(19) United States
(12) Patent Application Publication
(10) Pub. No.: US 2021/0141142 A1
(43) Pub. Date: May 13, 2021

(54) LIGHT-GUIDE PLATE UNIT, LIQUID CRYSTAL DISPLAY DEVICE, AND METHOD FOR MANUFACTURING LIGHT-GUIDE PLATE UNIT

(71) Applicant: SAKAI DISPLAY PRODUCTS CORPORATION, Sakai-shi, Osaka (JP)

(72) Inventor: HIROKI FUKAI, Sakai-shi, Osaka (JP)

(21) Appl. No.: 17/057,572

(22) PCT Filed: May 30, 2018
(86) PCT No.: PCT/JP2018/020845

§ 371 Date: Nov. 20, 2020

(51) Int. Cl. F21V 8/00; G02F 1/1335

(52) U.S. Cl. CPC G02B 6/0031; G02F 1/133524; G02B 6/0065

(57) ABSTRACT

A light-guide plate unit according to an embodiment of the present invention comprises: a light-guide plate comprising an incident surface on which light is incident, an emitting surface which is substantially orthogonal to the incident surface and from which the light being incident on the incident surface is emitted, and a back surface thereof; an adhesive layer being provided to the back surface; and an irregular reflection plate that has an irregular reflection surface directed toward the light-guide plate so as to reflect and scatter a part of the light being incident on the incident surface, and that is bonded onto the back surface via the adhesive layer. The irregular reflection plate has, formed on the irregular reflection surface, a plurality of apertures formed by recesses and/or through-holes, and adheres to the adhesive layer at portions, other than the apertures, of the irregular reflection surface.

### TECHNICAL FIELD

The invention relates to a light-guide plate unit, a liquid crystal display apparatus, and a method for manufacturing light-guide plate unit.

### BACKGROUND ART

For an edge-light type surface light emitting apparatus in which a light source is arranged in proximity to the edge of a light emitting surface of surface light emitting apparatuses being used in liquid crystal display apparatuses, a light-guide plate to guide light from the light source to the entire emitting surface is used. The light-guide plate is provided with a reflection plate as needed to reflect, toward the emitting surface, light leaking out of a surface (a back surface) being opposite to the emitting surface. Moreover, dot patterns to scatter light propagating in the light-guide plate toward the emitting surface are formed on the back surface of light-guide plate using ink containing white pigments. For example, Patent Document 1 discloses forming dot patterns on the back surface of a light-guide plate using a material having adhesiveness and adhering the light-guide plate and a reflection plate using the dot patterns. Light being incident into the light-guide plate from the light source is scattered at portions in which the dot patterns are formed to be emitted from the emitting surface and, at a portion without any dot patterns, is totally reflected at the interface between the light-guide plate and air to propagate further ahead. In this way, achieving uniformization of luminance at the emitting surface is intended.

### PRIOR ART DOCUMENT

### Patent Document

Patent Document 1: JP 5834767 B

### SUMMARY OF THE INVENTION

### Problem to be Solved by the Invention

Unless a scattering portion such as the dot patterns in Patent Document 1 and a total reflection portion to cause light to propagate to a region ahead is appropriately formed in a light-guide plate unit, it is not possible to cause light to propagate as intended in the light-guide plate, possibly causing luminance non-uniformity at the emitting surface. Moreover, the joining strength between the light-guide plate and the reflection plate not being sufficient could cause luminance at the emitting surface to be unstable.

Thus, an object of the invention is to provide a light-guide plate unit that can emit light stably at luminance of high uniformity across the emitting surface and a manufacturing method for such a light-guide plate unit, and a liquid crystal display apparatus that can display an image with good quality by using light from such a light-guide plate unit.

### Means to Solve the Problem

A light-guide plate unit according to a first embodiment of the present invention comprises: a light-guide plate comprising an incident surface on which light from a light source is incident, an emitting surface from which light being incident on the incident surface is emitted, and a back surface of the emitting surface, the emitting surface being substantially orthogonal to the incident surface; an adhesive layer being provided on a substantially entire surface of the back surface; and an irregular reflection plate being bonded to the back surface via the adhesive layer and comprising an irregular reflection surface facing the light-guide plate, wherein the irregular reflection surface reflects and scatters a part of the light being incident on the incident surface, wherein the irregular reflection plate comprises a plurality of apertures, on the irregular reflection surface, being formed by either one or both of a plurality of recesses and a plurality of through holes and adheres to the adhesive layer at a portion other than the plurality of apertures on the irregular reflection surface.

A liquid crystal display apparatus according to a second embodiment of the present invention at least comprises: the light-guide plate unit according to the first embodiment; a light source being arranged so as to face the incident surface of the light-guide plate; and a liquid crystal display panel to display an image using light emitted from the emitting surface, the liquid crystal display panel being arranged so as to face the emitting surface of the light-guide plate.

A method for manufacturing light-guide plate unit according to a third embodiment of the present invention comprises: preparing a light-guide plate comprising an incident surface on which light from a light source is to be incident, an emitting surface from which light being incident on the incident surface is to be emitted, and a back surface of the emitting surface; and an irregular reflection plate comprising an irregular reflection surface to reflect and scatter light; providing an adhesive layer on the back surface; and bonding the irregular reflection plate onto the back surface via the adhesive layer with the irregular reflection surface facing the light-guide plate, wherein in preparing of the irregular reflection plate, a plurality of apertures is formed on the irregular reflection surface by forming, in the irregular reflection plate, either one or both of a plurality of recesses and a plurality of through holes; and in bonding of the irregular reflection plate, a portion other than the apertures on the irregular reflection surface is caused to adhere to the adhesive layer.

### Effects of the Invention

The first embodiment of the present invention makes it possible to emit light stably at luminance of high uniformity across the emitting surface. Moreover, the second embodiment of the present invention makes it possible to display an image with good quality in a liquid crystal display apparatus by using light from such a light-guide plate unit. Furthermore, the third embodiment of the present invention makes it possible to easily manufacture a light-guide plate unit that can emit light stably at luminance of high uniformity across the emitting surface.

### BRIEF DESCRIPTION OF THE DRAWINGS

FIG. 1 shows a plan view of one example of a light-guide plate unit according to one embodiment of the present invention.

FIG. 2A shows a cross-sectional view along a line IIA-IIA in FIG. 1.

FIG. 2B shows an enlarged view of a IIB portion in FIG. 2A.

FIG. 3A shows a cross-sectional view of a different example of an aperture in the light-guide plate unit according to the one embodiment.

FIG. 3B shows a cross-sectional view of a different example of the aperture in the light-guide plate unit according to the one embodiment.

FIG. 3C shows a cross-sectional view of a different example of the aperture in the light-guide plate unit according to the one embodiment.

FIG. 4A shows a plan view of a different example of the apertures in the light-guide plate unit according to the one embodiment.

FIG. 4B shows a plan view of a different example of the apertures in the light-guide plate unit according to the one embodiment.

FIG. 4C shows a plan view of a different example of the apertures in the light-guide plate unit according to the one embodiment.

FIG. 4D shows a plan view of a different example of the apertures in the light-guide plate unit according to the one embodiment.

FIG. 5 shows a cross-sectional view of one example of a liquid crystal display apparatus according to one embodiment of the present invention.

FIG. 6 shows one example of a method for manufacturing light-guide plate unit according to one embodiment of the present invention.

FIG. 7 shows one example of a forming process of aperture in the method for manufacturing light-guide plate unit according to the one embodiment.

FIG. 8 shows a different example of the forming process of the aperture in the method for manufacturing light-guide plate unit according to the one embodiment.

FIG. 9 shows an example of forming the aperture in an irregular reflection plate collection plate in the method for manufacturing light-guide plate unit according to the one embodiment.

### EMBODIMENT FOR CARRYING OUT THE INVENTION

The inventor has found that the propagation characteristics of light in a light-guide plate does not stabilize with the structure in which a reflection plate is adhered to the back surface of the light-guide plate via dot patterns to irregularly reflect light and, therefore, it is difficult to obtain luminance having uniformity as intended on the emitting surface. In other words, the inventor has found that variations easily occur in the amount of each of light being totally reflected and light traveling toward the emitting surface since variations occur in the size of each of dots in the dot patterns or deforming occurs in each of the dots being sandwiched between the reflection plate and the light-guide plate. Moreover, the inventor has also found that it is difficult to obtain a sufficient adhesive strength with the structure in which the reflection plate adheres to the light-guide plate using the dot patterns as an adhesive as in Patent document 1. This is believed to be due to a sufficient adhesive area between the dot patterns and the reflection plate being difficult to be obtained since not all of the dots and the reflection plate can be brought into contact due to variations in height of each of the dots, or each of the dots has a shape of a spherical segment or a cone.

While the adhesive area can be increased by enlarging each of the dots, it is difficult to sufficiently enlarge each of the dots in view of obtaining luminance being uniform in the emitting surface. Moreover, while it is preferable to decrease the hardness of each of the dots that also serves as an adhesive from the viewpoint of improving the adhesive strength, this could make an occurrence of deforming of each of the dots easy. In this way, it is believed to be difficult to simultaneously increase both uniformity of luminance at the emitting surface and adhesive strength between the light-guide plate and the reflection plate with the structure to provide the dot patterns on the back surface of the light-guide plate.

Thus, the inventor has further studied arduously to satisfy both of the uniformity of luminance and the adhesive strength and arrived at providing an adhesive layer on substantially the entire surface of the back surface of the light-guide plate, and causing the surface of the adhesive layer and an irregular reflection surface that scatters and reflects light in the reflection plate to adhere to each other. Causing the surfaces to adhere to each other in this way makes it possible to firmly join the light-guide plate and the reflection plate (the irregular reflection plate) via the adhesive layer. Then, the inventor has found that a portion on which light can be totally reflected can be formed at the interface between the adhesive layer and the irregular reflection plate by forming an aperture comprising a recess on the irregular reflection surface. Such a configuration makes it possible to cause a part of light in the light-guide plate to be irregularly reflected, in an appropriate manner, everywhere toward the emitting surface and to cause a part of light in the light-guide plate to be further propagated in a direction being farther away from the light source, while obtaining a sufficient joining strength between the light-guide plate and the irregular reflection plate. In other words, this can cause light being uniform in the surface of the emitting surface to be emitted from the light-guide plate.

Hereinafter, a light-guide plate unit, a liquid crystal display apparatus, and a method for manufacturing light-guide plate unit according to embodiments of the present invention are explained with reference to the drawings. Material and shape of each of the constituting elements, and relative positional relationships thereof according to the embodiments to be explained below are merely exemplary. The light-guide plate unit, the liquid crystal display apparatus, and the method for manufacturing light-guide plate unit according to the present invention are not to be restrictively interpreted thereby.

[Light Guide Plate Unit]

FIG. 1 shows a plan view of a light-guide plate unit 1 according to a first embodiment. FIG. 2A shows a cross-sectional view along a line IIA-IIA in FIG. 1 of the light-guide plate unit 1, and FIG. 2B shows an enlarged view of an IIB portion in FIG. 2A. The light-guide plate unit 1 according to the present embodiment comprises: a light-guide plate 2 comprising an incident surface 21 on which light from a light source LS is incident, an emitting surface 22, and a back surface 23; an adhesive layer 3 being provided on substantially the entire surface of the back surface 23; and an irregular reflection plate 4 being bonded to the back surface 23 via the adhesive layer 3. The emitting surface 22 is substantially orthogonal to the incident surface and the back surface 23 is oriented in a direction being substantially opposite to the emitting surface 22. The light being incident on the incident surface 21 is emitted from the emitting surface 22. The irregular reflection plate 4 comprises an irregular reflection surface 41, which reflects and scatters a part of the light being incident on the incident surface 21, facing the light-guide plate 2, and comprises a plurality of apertures 42 on the irregular reflection surface 41. Then, the irregular reflection plate 4 adheres to the adhesive layer 3 at a portion other than the plurality of apertures 42 on the irregular reflection surface 41. In the examples in FIGS. 2A and 2B, the plurality of apertures 42 are formed by a plurality of recesses being provided on the irregular reflection surface 41. As described below, the plurality of apertures 42 can be formed by a plurality of through holes or can be formed by both the recesses and the through holes.

According to the embodiment, as shown in FIG. 2A, the back surface 23 of the light-guide plate 2 and the irregular reflection surface 41 of the irregular reflection plate 4 adhere to each other via the adhesive layer 3. In other words, the light-guide plate 2 and the irregular reflection plate 4 are bonded together at their respective surfaces via the adhesive layer 3. Compared to adhering via the previously-described dot patterns in Patent Document 1, the contact area between each of the light-guide plate 2 and the irregular reflection plate 4, and the adhesive layer 3 can be increased. Moreover, contact between each of the light-guide plate 2 and the irregular reflection plate 4, and the adhesive layer 3 is not via a projection that tends to be deformed, like the dot patterns, so the variation in the contact area is believed to be also small. Therefore, the joining strength of the light-guide plate 2 and the irregular reflection plate 4 can be stabilized, and luminance at the emitting surface 22 can be stabilized.

Moreover, the present embodiment makes it possible to obtain uniformity being high with respect to luminance at the emitting surface 22 by providing the plurality of apertures 42. In other words, as shown in FIG. 2B, lights L1, L2 that travel toward the irregular reflection plate 4 of lights propagating in the light-guide plate 2 reaches the aperture 42, or a portion other than the aperture 42 on the irregular reflection surface 41. The light L1 reaching the portion other than the aperture 42 is irregularly reflected, or in other words, is reflected and scattered on the irregular reflection surface 41 and again is incident into the light-guide plate 2 from the back surface 23 to travel toward the emitting surface 22 while being diffused. Such an irregular reflection occurs everywhere on the irregular reflection surface 41 except for the aperture 42, causing light to be emitted from substantially the entire surface of the emitting surface 22.

On the other hand, the light L2 reaching the aperture 42 is reflected (preferably, totally reflected) at the interface between the adhesive layer 3 and air (air in the aperture 42). Then, the light L2 is again incident into the light-guide plate 2 from the back surface 23 preferably at an angle at which the light can be totally reflected also at the emitting surface 22, and propagates ahead (in a direction being farther away from the incident surface 21 and the light source LS) in the light-guide plate 2. This light thereafter propagates in the light-guide plate 2 until when this light is irregularly reflected by reaching a portion other than the aperture 42 on the irregular reflection surface 41 to be emitted from the emitting surface 22. Therefore, a part of light being emitted in the light source LS can be made to reach a position being distant from the light source LS, and it is possible to emit light at luminance being appropriate even at a position being distal from the light source LS on the emitting surface 22. Therefore, light can be emitted from the light-guide plate 2 at luminance being uniform at the emitting surface 22.

Moreover, according to the present embodiment, by adjusting the ratio between the area of the portion other than the aperture 42 and the area of the aperture 42, it is possible to adjust luminance at the emitting surface 22. In other words, the distribution of luminance in the emitting surface 22 can be adjusted by adjusting the ratio of the area of a portion other than the plurality of apertures 42 on the irregular reflection surface 41 to the area of the irregular reflection surface 41. For example, the ratio of the area of the portion other than the plurality of apertures 42 on the irregular reflection surface 41 to the area of the irregular reflection surface 41 is preferably greater than or equal to 0.5 and less than or equal to 0.7 and more preferably greater than or equal to 0.55 and less than or equal to 0.65. By providing the aperture 42 with approximately the ratio as described above, it is possible to make it easier to increase uniformity of luminance at the emitting surface 22.

In the example in FIG. 1, the aperture 42 has a circular shape. The multiple apertures 42 are arranged in a grid shape with a pitch P in a direction of a column along the incident surface 21 and in a direction of a row being orthogonal to the incident surface 21 and are further arranged, in between each of the columns, for each one of the columns deviating in the column direction by 0.5×P relative to the adjacent columns. While the pitch P is not limited in particular, the length being approximately greater than or equal to 0.5 mm and less than or equal to 1.5 mm is exemplified. In that case, from a viewpoint of realizing the previously-described area ratio between the portion other than the aperture 42 and the irregular reflection surface 41, the diameter φ of the circularly-shaped aperture 42 in the example in FIG. 1 is preferably approximately greater than or equal to 0.25 mm and less than or equal to 0.75 mm, and can be 0.5 mm, for example.

In the examples in FIGS. 1, 2A, and 2B, the plurality of apertures 42 is formed by a recess having a shape of a spherical segment. However, the aperture 42 can be formed by a recess having a shape other than the shape of the spherical segment as long as it can form the interface between the adhesive layer 3 and air at the interface between the adhesive layer 3 and the irregular reflection plate 4, or, in other words, at the irregular reflection surface 41. FIGS. 3A to 3C show examples of the aperture 42 being formed by a recess or a through hole of a shape other than the shape of the spherical segment. In FIGS. 3A to 3C, only the adhesive layer 3 and the irregular reflection plate 4 are shown, so that illustration of the light-guide plate 2 is omitted.

The aperture 42 can be formed by a recess having a circular cylinder or a prism shape as exemplified in FIG. 3A or can be formed by a recess having a circular cone or a pyramid shape as exemplified in FIG. 3B. Moreover, as exemplified in FIG. 3C, rather than being a bottomed recess, the plurality of apertures 42 can be formed by through holes penetrating the irregular reflection plate 4 in the thickness direction. The aperture 42 is provided to cause a desired proportion of light having reached the irregular reflection plate 4 to be reflected (preferably totally reflected) at the interface between the io irregular reflection plate 4 and the adhesive layer 3 without causing it to be irregularly reflected to propagate further ahead. Therefore, as long as the aperture 42 has a desired size, the depth of the recess to form the aperture 42, and the shape of the recess at a cross section being parallel to the thickness direction of the irregular reflection plate 4 are not limited in particular, and, moreover, the aperture 42 can be formed by the through hole.

FIGS. 4A to 4D show further different examples of the aperture 42 according to the embodiment in plan views showing the irregular reflection surface 41 of the irregular reflection plate 4. In the example in FIG. 4A, the apertures 42 are formed in the irregular reflection plate 4 at the density being lower the farther away from than closer to the incident surface 21 (see FIG. 1) of the light guide plate 2, or, in other words, closer to the light source LS. In the light-guide plate unit 1 (see FIG. 1), it is preferable to propagate a greater amount of light ahead (in a direction being farther away from the incident surface 21) at a position being closer to the incident surface 21 than at a position being farther away from the incident surface 21. In this way, it is possible to reduce the difference in light (amount of light) traveling toward the emitting surface 22 that can occur between portions of the light-guide plate 2, the portions being a portion closer to the incident surface 21 and a portion farther from the incident surface 21. Therefore, light being incident from the incident surface 21 can be emitted from the emitting surface 22 at luminance being uniform at the emitting surface 22. As described previously, light reaching the aperture 42 propagates ahead in the light-guide plate 2 without being irregularly reflected. Therefore, the apertures 42 being formed at the density lower the farther away from than closer to the incident surface 21 cause a greater amount of light to be propagated ahead at a position being closer to the incident surface 21 than at a position being farther away from the incident surface 21, making it possible to obtain luminance being high in uniformity at the emitting surface 22.

The apertures 42 in FIG. 4A are formed at the density higher in a region close to the incident surface 21 (see FIG. 1) being close to the light source LS than in a region farther away from the incident surface 21. By the apertures 42 changing the size thereof rather than changing the number thereof per unit area in this way, the apertures 42 can be formed at the density being higher in a region close to the incident surface 21 than that in a region farther away from the incident surface 21. In other words, as exemplified in FIG. 4B, the area of the aperture 42 can be smaller the farther away from than closer to the incident surface 21. Even this case causes a greater amount of light to be propagated ahead at a position being closer to the incident surface 21 than at a position being farther away from the incident surface 21, making it possible to obtain luminance being high in uniformity at the emitting surface 22. By the apertures 42 being formed in a large number per unit area and in a large area, the apertures 42 can be formed at the density being higher in a region close to the incident surface 21 than in a region farther away from the incident surface 21.

The planar shape of the aperture 42 at the irregular reflection surface 41 is not limited to being circular as exemplified in each of the drawings being previously referred to. For example, the aperture 42 can have a hexagonal planar shape as shown in FIG. 4C, or it can have a planar shape of a polygon having an arbitrary number of vertexes. In that case, as shown in FIG. 4C, a portion other than the aperture 42 on the irregular reflection surface 41 can partially have a constant width between two adjacent apertures 42. Therefore, luminance at the emitting surface 22 can be easily estimated, so that design of the aperture 42 can be easy. Even in a case that the aperture 42 has a polygonal planar shape as shown in FIG. 4C, the apertures 42 are preferably formed at a region close to the light source LS, or, in other words, in a region close to the incident surface 21 (see FIG. 1) of the light-guide plate 2 at a density being higher than that in a region farther away from the incident surface 21.

A plurality of light sources LS can be arranged for the light-guide plate unit 1 according to the present embodiment so as to face each other via the light-guide plate unit 1 to be sandwiched between the light sources. In that case, the light-guide plate 2 (see FIG. 1) can comprise two incident surfaces 21 to face the respective light sources LS. Then, as shown in FIG. 4D, the apertures 42 of the irregular reflection plate 4 are preferably formed at a region close to each of the light sources LS being arranged to face each other at a density being higher than that in a region farther away from each light source LS. In other words, the apertures 42 are preferably formed at a region close to the two incident surfaces 21 configured by either of two opposite lateral surfaces of the light-guide plate 2 at the density being higher than that in a region farther away from the two incident surfaces 21. In other words, the apertures 42 are preferably formed at a region of the irregular reflection plate 4 being in proximity to each of the edges facing either of the light sources LS facing each other at the density being higher than that in a central region of the irregular reflection plate 4 in a direction along which the light sources LS face each other. In that case, luminance being high in uniformity at the emitting surface 22 can be obtained for the same reason as the reason described previously for a case in which the incident surface 21 is singular as in the example in FIG. 1.

The irregular reflection plate 4 can be obtained by providing the aperture 42 in an irregular reflection surface of a general irregular reflection plate. While polyester such as polyethylene terephthalate or polybutylene terephthalate, polycarbonate, or polypropylene can be exemplified as a material for the irregular reflection plate 4, the material for the irregular reflection plate 4 is not limited thereto. For example, the irregular reflection plate 4 can be formed using a metal such as aluminum, stainless steel, or titanium. Moreover, the irregular reflection plate 4 can have the rigidity such that it cannot be easily bent or it can have a film-like form having flexibility.

The irregular reflection plate 4 can have a fine convexo-concavity at the irregular reflection surface 41 such that light irradiating the irregular reflection surface 41 is irregularly reflected thereon. The height difference between the recess and the projection of the convexo-concavity is greater than or equal to 50 μm and less than or equal to 200 μm, for example. Such a convexo-concavity can be produced due to the porosity of the irregular reflection plate 4 or can be produced by a mechanical process such as sandblasting. While the less the thickness of the irregular reflection plate 4 is, the more preferable it is from the viewpoint of thinning of the light-guide plate unit 1, the thickness of the irregular reflection plate 4 is not to be limited to a specific thickness.

The irregular reflection surface 41 of the irregular reflection plate 4 adheres to the adhesive layer 3. Therefore, the irregular reflection surface 41 preferably has a suitable convexo-concavity to secure a large contact surface not only from the viewpoint of irregular reflectance as previously described but also from the viewpoint of obtaining a good adhesiveness to the adhesive layer 3. The arithmetic average roughness (Ra) of the irregular reflection surface 41 is preferably greater than or equal to 50 μm and less than or equal to 100 μm. In that case, a good adhesiveness can be obtained between the adhesive layer 3 and the irregular reflection plate 4.

The adhesive layer 3 can be configured with an arbitrary material having a light-transmitting property and having a good adhesiveness with respect to the light-guide plate 2 and the irregular reflection plate 4. The term “adhesiveness” can refer to the property such that adherends together are firmly joined to such a degree that it is impossible to peel the adherends off without involving destruction of the adherends, or it can refer to the property being of such a degree as to bring the adherends in close contact with each other to the degree that it is possible to peel the adherends off without destroying the adherends or leaving an adhesive component such as a glue on the adhesive surface. An acrylic, urethane, or silicone adhesive can be exemplified as a material for the adhesive layer 3. The adhesive layer 3 can be formed by depositing a film-like adhesive sheet between the light-guide plate 2 and the irregular reflection plate 4, or by subjecting the back surface 23 of the light-guide plate 2 with a liquid adhesive io being applied thereon to heating or ultraviolet irradiation, for example.

As previously described, light propagating in the light-guide plate unit 1 is preferably totally reflected at the interface between the adhesive layer 3 and air in the aperture 42. Therefore, the adhesive layer 3 preferably has a refractive index being sufficiently higher than that of air. On the other hand, in the light-guide plate unit 1 according to the present embodiment, light does not necessarily have to be totally reflected in between the light-guide plate 2 and the adhesive layer 3. Therefore, a material for each of the adhesive layer 3 and the light-guide plate 2 can be selected from a wide range with respect to the refractive index thereof. For example, the refractive index of the adhesive layer 3 can be greater than the refractive index of the light-guide plate 2. As one example, in a case that the light-guide plate 2 is formed using a polymethyl methacrylate resin (PMMA) having the refractive index of approximately 1.5 in the visible light range, the adhesive layer 3 can have the refractive index being greater than or equal to 1.6 and less than or equal to 1.7. For example, the refractive index of the adhesive layer 3 can be increased by incorporating particles having a high refractive index, such as titanium oxide, in the adhesive layer 3.

It suffices that the thickness of the adhesive layer 3 be large in such a degree that the light-guide plate 2 and the irregular reflection plate 4 can surely be joined and be a thickness such that light being incident into the adhesive layer 3 from the light-guide plate 2 can surely reach the irregular reflection surface 41 of the irregular reflection plate 4. The thickness of the adhesive layer 3 is, preferably, greater than or equal to 0.1 mm and less than or equal to 0.5 mm and, more preferably, greater than or equal to 0.2 mm and less than or equal to 0.4 mm. The adhesive layer 3 having such a thickness makes it possible to cause even light being incident into the adhesive layer 3 at a large angle of refraction at the interface between the light-guide plate 2 and the adhesive layer 3 to reach the irregular reflection surface 41 and makes it possible to cause the light-guide plate 2 and the irregular reflection plate 4 to be joined together in a substantially sure manner.

As the light-guide plate 2, an organic glass plate being formed with an acrylic resin such as the previously-described PMMA and a polycarbonate resin, and an inorganic glass plate can be exemplified. However, the material for the light-guide plate 2 is not to limited thereto, so that the light-guide plate 2 can be formed using an arbitrary light-transmitting material.

[Liquid Crystal Display Apparatus]

Hereinafter, a liquid crystal display apparatus according to a second embodiment is described with reference to the drawing. FIG. 5 shows a cross-sectional view of a liquid crystal display apparatus 10 according to the second embodiment. As shown in FIG. 5, the liquid crystal display apparatus 10 at least comprises: a light-guide plate unit 1 as previously described according to the first embodiment; a light source 11 being arranged so as to face an incident surface 21 of a light-guide plate 2; and a liquid crystal display panel 12 to display an image using light emitted from an emitting surface 22 of the light-guide plate 2, the liquid crystal display panel 12 being arranged so as to face the emitting surface 22. In the example in FIG. 5, the liquid crystal display apparatus 10 further comprises a housing 13, and the liquid crystal display 12, the light source 11, and the light-guide plate unit 1 are housed in the housing 13. The housing 13 is formed using a polystyrene resin, a polycarbonate resin, or an acrylonitril-butadiene-styrene resin. FIG. 5 is a cross-sectional view at a position corresponding to a cutting line being indicated as a IIA-IIA line in FIG. 1 with respect to the light-guide plate unit 1.

The light-guide plate unit 1 being provided to the liquid crystal display apparatus 10 can have any of the structures that each of the examples as previously described of the light-guide plate unit 1 has, or it can be formed using any of materials being previously exemplified. In other words, the light-guide plate unit 1 being provided to the liquid crystal display apparatus 10 can comprise a plurality of apertures 42 on an irregular reflection surface 41 of an irregular reflection plate 4, and a portion other than the apertures 42 on the irregular reflection surface 41 is adhered to the adhesive layer 3 being provided at the back surface 23 of the light-guide plate 2. The ratio of the area of the portion other than the plurality of apertures 42 on the irregular reflection surface 41 to the area of the irregular reflection surface 41 can be greater than or equal to 0.5 and less than or equal to 0.7 and the arithmetic average roughness of the irregular reflection surface 41 is greater than or equal to 50 μm and less than or equal to 100 μm. Moreover, the apertures 42 can be formed in the irregular reflection plate 4 at a density being lower the farther away from than closer to the incident surface 21, and the area of the aperture 42 can be smaller the farther away from than closer to the incident surface 21. Moreover, the refractive index of the adhesive layer 3 can be higher than the refractive index of the light-guide plate 2, while the thickness of the adhesive layer 3 can be greater than or equal to 0.1 mm and less than or equal to 0.5 mm.

While a plurality of light-emitting diodes (LED) or a cold cathode fluorescent lamp (CCFL) can be exemplified as the light source 11, the light source 11 is not limited to the LED and the CCFL as long as light can be emitted therefrom.

For the liquid crystal display panel 12, a general liquid crystal display panel can be used. In other words, while the liquid crystal display panel 12 is not shown in detail, it can comprise a TFT substrate comprising a polarizer facing the light-guide plate unit 1 as well as comprising a drive circuit being made up of thin film transistors (TFTs), a liquid crystal layer being provided on the TFT substrate via an alignment layer, and an opposing substrate being arranged to face the TFT substrate via the liquid crystal layer, the opposing substrate comprising an alignment layer, a common electrode, a color filter, and a polarizer.

The liquid crystal display apparatus 10 according to the present embodiment comprises the previously-described light-guide plate unit 1 according to the first embodiment, making it possible to display an image in a good quality with a small luminance non-uniformity.

[A Method for Manufacturing Light-Guide Plate Unit]

Hereinafter, a method for manufacturing light-guide plate unit according to a third embodiment is described with reference to the drawings using a light-guide plate unit 1 shown in FIGS. 1 and 2A as an example. As shown in FIG. 6, the method for manufacturing light-guide plate unit according to the present embodiment comprises: preparing a light-guide plate 2 comprising an incident surface 21 on which light from a light source (see FIG. 1) is to be incident, an emitting surface 22 from which light being incident on the incident surface 21 is to be emitted, and a back surface 23; and an irregular reflection plate 4 comprising an irregular reflection surface 41 to reflect and scatter light; providing an adhesive layer 3 on the back surface 23 of the light-guide plate 2; and bonding the irregular reflection plate 4 onto the back surface 23 via the adhesive layer 3 with the irregular reflection surface 41 facing the light-guide plate 2. The back surface 23 of the light-guide plate 2 is oriented in a direction being opposite to the emitting surface 22. Then, in the method for manufacturing light-guide plate unit according to the present embodiment, in preparing of the irregular reflection plate 4, a plurality of apertures 42 is formed on the irregular reflection surface 41 by forming, in the irregular reflection plate 4, either one or both of a plurality of recesses and a plurality of through holes. Moreover, in bonding of the irregular reflection plate 4 onto the back surface 23 of the light-guide plate 2, a portion other than the aperture 42 on the irregular reflection surface 41 is caused to adhere to the adhesive layer 3. Providing the plurality of apertures 42 on the irregular reflection surface 41 of the irregular reflection plate 4 and causing the adhesive layer 3 to adhere to the irregular reflection surface 41 in this way, make it possible to manufacture the light-guide plate unit 1 that can stably emit light at luminance being high in uniformity across the emitting surface 22.

As the light-guide plate 2, a glass plate formed of an inorganic glass such as silicate glass, or a glass plate formed of an organic glass such as an acrylic resin including PMMA or a polycarbonate resin can be prepared. The inorganic glass plate can be formed using a fusion method including a floating method, for example, while the organic glass plate can be formed by molding a resin to be a material, for example.

As the irregular reflection plate 4, a sheet, a film, or a hard plate-like member being formed primarily using a foamed plastic such as polyester including polyethylene terephthalate or polybutylene terephthalate, polycarbonate, or polypropylene can be prepared. Moreover, a plate material formed of a resin other than the foamed plastic or a metal such as aluminum or stainless steel can be prepared, and the irregular reflection plate 4 can be prepared by subjecting the surface thereof to a mechanical process such as sandblasting or a chemical process such as etching.

The adhesive layer 3 can be provided by placing a film having light transmitting property and adhesiveness, the film being formed with an acrylic resin, an urethane resin, or a silicone resin as a main component, for example, between the back surface 23 of the light-guide plate 2 and the irregular reflection surface 41 of the irregular reflection plate 4. The adhesive layer 3 can also be provided by applying a liquid resin that can exhibit adhesiveness onto the back surface 23 of the light-guide plate 2 and curing the liquid resin using ultraviolet rays or heat. In a case that the liquid resin to form the adhesive layer 3 has viscosity in such a degree as to not fill up the aperture 42, such a resin can be applied onto the irregular reflection surface 41 of the irregular reflection plate 4. The adhesive layer 3 can be provided using a sheet-like adhesive or a liquid adhesive called an OCA (Optical Clear Adhesive) or an OCR (Optical Clear Resin).

The irregular reflection plate 4 is bonded to the back surface 23 via the adhesive layer 3 with the irregular reflection surface 41 facing the light-guide plate 2. More specifically, each of the back surface 23 of the light-guide plate 2 and the portion other than the aperture 42 on the irregular reflection surface 41 adheres to the adhesive layer 3, so that, as a result, the light-guide plate 2 and the irregular reflection plate 4 are joined. In the bonding, the light-guide plate 2 and the irregular reflection plate 4 can be pressurized with appropriate force toward each other. In a case that the adhesive layer 3 is provided using the liquid adhesive, the adhesive layer 3 can be cured by heating in a state of being sandwiched between the light-guide plate 2 and the irregular reflection plate 4.

An arbitrary processing method can be used for forming the plurality of apertures 42. For example, with a projection corresponding to the aperture 42 being provided on the surface of a mold (not shown), the aperture 42 can be formed by pressing the projection against the irregular reflection surface 41 of the irregular reflection plate 4. As this mold, a mold being flat-plate shaped or block-shaped and having a flat surface can be used, or a circular cylinder-shaped mold can be used.

As shown in FIG. 7, in a case that a circular cylinder-shaped mold C is used, a projection C1 corresponding to the aperture 42 is provided on the lateral surface of the mold C. Then, the circular cylinder-shaped mold C is rotated around the central axis thereof and is rolled on the irregular reflection surface 41 of the irregular reflection plate 4, and the projection C1 being provided on the lateral surface of the mold C is pressed against the irregular reflection surface 41. As a result, the aperture 42 is formed. In this way, forming the plurality of apertures 42 can comprise pressing the plurality of projections C1 being formed on the lateral surface of the mold C against the irregular reflection surface 41 of the irregular reflection plate 4 while rotating the circular cylinder-shaped mold C. In that case, compared to the case in which the flat plate-shaped or block-shaped mold is used, the mold can be downsized, or necessary pressing force can be decreased since not all of the plurality of apertures 42 are formed at once, so that the aperture 42 can be formed using a relatively small-sized press machine.

In the example in FIG. 7, the interval between the projections C1 being provided plurally in a peripheral direction R (rotating direction of the mold C) of the circular cylinder-shaped mold C is not constant, but gradually changes. In this way, changing the interval between the projections C1 in the peripheral direction R of the mold C makes it possible to change the interval between neighboring apertures 42 on the irregular reflection surface 41, as with the apertures 42 shown in FIG. 7. Therefore, the density of the apertures 42 at the irregular reflection surface 41 can be changed in the moving (rolling) direction of the mold C. The interval between neighboring projections C1 in the peripheral direction R of the mold C can gradually increase or can gradually decrease. For example, the projection C1 can be provided to the mold C such that the apertures 42 can be formed at a density being higher in a portion, in the irregular reflection surface 41, being close to the incident surface 21 (see FIG. 6) of the light-guide plate 2 than that in a portion being farther away the incident surface 21.

FIG. 7 shows an example in which the aperture 42 is formed by a spherical segment-shaped recess being formed to form the aperture 42, so that spherical segment-shaped projection C1 is provided. On the other hand, in a case that a recess such as in the previously referred example in FIG. 3A is formed in the irregular reflection plate 4, a circular cylinder-shaped or a prism-shaped projection C1 is formed, while, in a case that a recess such as the previously referred example in FIG. 3B is formed therein, a circular cone-shaped or a pyramid-shaped projection C1 is formed. Moreover, in a case that the aperture 42 is formed with a through hole as in the example in FIG. 3C, the projection C 1 having a height exceeding the thickness of the irregular reflection plate 4 can be formed.

FIG. 8 shows an example of a method of forming the aperture 42 with the recess exemplified in FIG. 3B, and one aperture 42 and a projection C1 to form the one aperture 42 are shown in an enlarged manner. The circular cone-shaped, or pyramid-shaped projection C1 being provided on a flat surface of the mold C and the mold C being moved in the downward direction in FIG. 8 cause the projection C1 to be pressed against the irregular reflection surface 41 of the irregular reflection plate 4. Forming the plurality of apertures 42 can comprise pressing the plurality of projections C1 being formed on the surface of the mold C in a tapered shape in this way against the irregular reflection surface 41. Then, in forming of the plurality of apertures 42 using the projection C1 being tapered in this way, the size of each one of the plurality of apertures 42 can be adjusted by adjusting a force F to press the plurality of projections C1 against the irregular reflection surface 41.

In other words, changing the force F to press the projection C1 makes it possible to change a depth D, from the irregular reflection surface 41, which the tip of the projection C1 reaches and makes it possible to change the cross-sectional area of the projection C1 at the irregular reflection surface 41 when the tip of the projection C1 reaches the predetermined depth D. Therefore, decreasing the force F makes it possible to form the aperture 42 being smaller, while increasing the force F makes it possible to form the aperture 42 being larger. The spherical segment shape such as a shape of the projection C1 shown in FIG. 7 is also included as a tapered shape. However, in a case that the projection C1 having circular cone-shape or pyramid-shape is used, the depth D to which the tip of the projection C is to reach can be calculated with a simple proportional calculation, for example. Therefore, it is possible to easily form the aperture 42 having a desired size.

In the method for manufacturing light-guide plate unit according to the present embodiment, in preparing of the irregular reflection plate 4, as shown in FIG. 9, an irregular reflection plate collection plate 40 comprising the plurality of irregular reflection plates 4 being arranged with a predetermined arrangement pitch P1 can be prepared. In that case, the multiple irregular reflection plates 4 before forming the aperture 42 (see FIG. 7) can efficiently be formed and, as described below, the aperture 42 can be formed efficiently. In the example in FIG. 9, three of the irregular reflection plates 4, each having a substantially rectangular planar shape, are arranged with the pitch P1 in the left-right direction (X direction) in FIG. 9 and three thereof are also arranged in the Y direction being orthogonal to the X direction. The number of irregular reflection plates 4 to be arranged in each of the directions in the irregular reflection plate collection plate 40 can be an arbitrary number other than three.

In a case that the irregular reflection plate collection plate 40 being exemplified in FIG. 9 is prepared and the aperture 42 is formed using the previously-described circular cylinder-shaped mold C, preferably, a circular cylinder-shaped mold C is used, the circular cylinder-shaped mold C having a length being substantially equal to the predetermined arrangement pitch P1 of the plurality of irregular reflection plates 4 as a peripheral length of the cross section being orthogonal to a direction of a central axis AC. The irregular reflection plate collection plate 40 is arranged such that the X direction in which the irregular reflection plates 4 are arranged with the pitch P1 and the central axis AC of the circular cylinder-shaped mold C are substantially orthogonal and the irregular reflection surface 41 and the central axis AC of the mold C are substantially parallel with each other. Then, the circular cylinder-shaped mold C is rolled along the X direction in which the irregular reflection plates 4 are arranged with the pitch P1. In this way, the apertures 42 (see FIG. 7) are substantially simultaneously formed for the plurality of irregular reflection plates 4 being arranged in a direction (Y direction in FIG. 9) being parallel to the central axis AC of the mold C. Moreover, the plurality of apertures 42 is formed continuously for the plurality of irregular reflection plates 4 being arranged with the pitch P1 in a direction being substantially parallel to the rolling direction of the mold C. Therefore, the plurality of apertures 42 can be very efficiently formed in the plurality of irregular reflection plates 4.

Furthermore, the circular cylinder-shaped mold C has a length being substantially equal to the pitch P1 of the plurality of irregular reflection plates 4 as a peripheral length of the cross section being orthogonal to the central axis AC direction. Therefore, by merely rolling the mold C in the X direction, it is possible to form the apertures 42 continuously in the plurality of irregular reflection plates 4 being lined up with the pitch P1 in the X direction and, even more, at an appropriate position in each of the irregular reflection plates 4. For example, even in a case that the density of the apertures 42 changes within the irregular reflection surface 41 as exemplified in FIG. 4A being previously referred to, the apertures 42 can be formed continuously in the plurality of irregular reflection plates 4 being lined up in the X direction and appropriately in each of the irregular reflection plates 4 without requiring alignment in the peripheral direction of the mold C for each of the irregular reflection plates 4. Each one of the plurality of irregular reflection plates 4 being arranged with the predetermined pitch P1 can be in direct contact with each other without being via a margin portion 43 shown in FIG. 9. In that case, the peripheral length of the cross section being orthogonal to the central axis AC direction of the circular cylinder-shaped mold C is preferably the same as the length of a side of the individual irregular reflection plate 4, the side being parallel to the X direction.

[Conclusion]

(1) A light-guide plate unit according to a first embodiment of the present invention comprises: a light-guide plate comprising an incident surface on which light from a light source is incident, an emitting surface from which light being incident on the incident surface is emitted, and a back surface of the emitting surface, the emitting surface being substantially orthogonal to the incident surface; an adhesive layer being provided on a substantially entire surface of the back surface; and an irregular reflection plate being bonded to the back surface via the adhesive layer and comprising an irregular reflection surface facing the light-guide plate, wherein the irregular reflection surface reflects and scatters a part of the light being incident on the incident surface, wherein the irregular reflection plate comprises a plurality of apertures, on the irregular reflection surface, being formed by either one or both of a plurality of recesses and a plurality of through holes and adheres to the adhesive layer at a portion other than the plurality of apertures on the irregular reflection surface.

The configuration according to (1) makes it possible to stably emit light at luminance being high in uniformity across the emitting surface.

(2) In the light-guide plate unit according to (1) in the above, a ratio of an area of the portion other than the plurality of apertures on the irregular reflection surface to an area of the irregular reflection surface can be greater than or equal to 0.5 and less than or equal to 0.7. In that case, uniformity of luminance at the emitting surface can be further increased.

(3) In the light-guide plate unit according to (1) or (2) in the above, an arithmetic average roughness (Ra) of the irregular reflection surface can be greater than or equal to 50 μm and less than or equal to 100 μm. In that case, a good adhesiveness between the adhesive layer and the irregular reflection can be obtained.

(4) In the light-guide plate unit according to any one of (1) to (3) in the above, the apertures can be formed in the irregular reflection plate at a density being lower the farther away from than closer to the incident surface. In that case, uniformity of luminance at the emitting surface can be further increased.

(5) In the light-guide plate unit according to any one of (1) to (4) in the above, an area of each of the apertures can be smaller the farther away from than closer to the incident surface. In that case, uniformity of luminance at the emitting surface can be further increased.

(6) In the light-guide plate unit according to any one of (1) to (5) in the above, a refractive index of the adhesive layer can be higher than a refractive index of the light-guide plate. In that case, options on materials for the light-guide plate and the adhesive layer can be broadened.

(7) In the light-guide plate unit according to any one of (1) to (6) in the above, a thickness of the adhesive layer can be greater than or equal to 0.1 mm and less than or equal to 0.5 mm. In that case, light being incident into the adhesive layer from the light-guide plate can substantially surely reach the irregular reflection surface and the light-guide plate and the irregular reflection plate can be substantially surely joined together.

(8) A liquid crystal display apparatus according to a second embodiment of the present invention at least comprises: the light-guide plate unit according to any one of (1) to (7) in the above; a light source being arranged so as to face the incident surface of the light-guide plate; and a liquid crystal display panel to display an image using light emitted from the emitting surface, the liquid crystal display panel being arranged so as to face the emitting surface of the light-guide plate.

The configuration according to (8) makes it possible to display an image in a good quality with a small luminance non-uniformity, in the liquid crystal display apparatus.

(9) A method for manufacturing light-guide plate unit according to a third embodiment of the present invention comprises: preparing a light-guide plate comprising an incident surface on which light from a light source is to be incident, an emitting surface from which light being incident on the incident surface is to be emitted, and a back surface of the emitting surface; and an irregular reflection plate comprising an irregular reflection surface to reflect and scatter light; providing an adhesive layer on the back surface; and bonding the irregular reflection plate onto the back surface via the adhesive layer with the irregular reflection surface facing the light-guide plate, wherein in preparing of the irregular reflection plate, a plurality of apertures is formed on the irregular reflection surface by forming, in the irregular reflection plate, either one or both of a plurality of recesses and a plurality of through holes; and in bonding of the irregular reflection plate, a portion other than the apertures on the irregular reflection surface is caused to adhere to the adhesive layer.

The configuration according to (9) makes it possible to easily manufacture a light-guide plate unit that can stably emit light at luminance being high in uniformity across the emitting surface.

(10) In the method for manufacturing light-guide plate unit according to (9) in the above, the forming the plurality of apertures can comprise pressing a plurality of projections against the irregular reflection surface, the plurality of projections being formed on a surface of a mold in a tapered shape; and, in forming of the plurality of apertures, a size of each one of the plurality of apertures can be adjusted by adjusting a force to press the plurality of projections against the irregular reflection surface. This makes it possible to easily form a plurality of apertures each having a desired size.

(11) In the method for manufacturing light-guide plate unit according to (9) in the above, forming the plurality of apertures can comprise, while rotating a circular cylinder-shaped mold, pressing a plurality of projections being formed on a lateral surface of the mold against the irregular reflection surface. This makes it possible to form an aperture using a relatively small-sized press machine.

(12) In the method for manufacturing light-guide plate unit according to (11) in the above, in preparing of the irregular reflection plate, an irregular reflection plate collection plate comprising a plurality of the irregular reflection plates being arranged with a predetermined pitch can be prepared, and the plurality of apertures can be continuously formed for the plurality of the irregular reflection plates being arranged in the irregular reflection plate collection plate using, as the circular cylinder-shaped mold, a circular cylinder-shaped mold having a length being substantially equal to the predetermined pitch as a peripheral length of a cross section being orthogonal to a direction of a central axis. This makes it possible to efficiently form a plurality of apertures in a plurality of irregular reflection plates.

### DESCRIPTION OF REFERENCE NUMERALS

1 LIGHT GUIDE PLATE UNIT

10 LIQUID CRYSTAL DISPLAY APPARATUS

11 LIGHT SOURCE

12 LIQUID CRYSTAL DISPLAY PANEL

2 LIGHT GUIDE PLATE

21 INCIDENT SURFACE

22 EMITTING SURFACE

23 BACK SURFACE

3 ADHESIVE LAYER

4 IRREGULAR REFLECTION PLATE

40 IRREGULAR REFLECTION PLATE COLLECTION PLATE

41 IRREGULAR REFLECTION SURFACE

42 APERTURE

C MOLD

C1 PROJECTION

1. A light-guide plate unit comprising:
a light-guide plate comprising an incident surface on which light from a light source is incident, an emitting surface from which light being incident on the incident surface is emitted, and a back surface of the emitting surface, the emitting surface being substantially orthogonal to the incident surface;
an adhesive layer being provided on a substantially entire surface of the back surface; and
an irregular reflection plate being bonded to the back surface via the adhesive layer and comprising an irregular reflection surface facing the light-guide plate, wherein the irregular reflection surface reflects and scatters a part of the light being incident on the incident surface, wherein
the irregular reflection plate comprises a plurality of apertures, on the irregular reflection surface, being formed by either one or both of a plurality of recesses and a plurality of through holes and adheres to the adhesive layer at a portion other than the plurality of apertures on the irregular reflection surface.

2. The light-guide plate unit according to claim 1, wherein a ratio of an area of the portion other than the plurality of apertures on the irregular reflection surface to an area of the irregular reflection surface is greater than or equal to 0.5 and less than or equal to 0.7.

3. The light-guide plate unit according to claim 1, wherein an arithmetic average roughness (Ra) of the irregular reflection surface is greater than or equal to 50 μm and less than or equal to 100 μm.

4. The light-guide plate unit according to claim 1, wherein the apertures are formed in the irregular reflection plate at a density being lower the farther away from than closer to the incident surface.

5. The light-guide plate unit according to claim 1, wherein an area of each of the apertures is smaller the farther away from than closer to the incident surface.

6. The light-guide plate unit according to claim 1, wherein a refractive index of the adhesive layer is higher than a refractive index of the light-guide plate.

7. The light-guide plate unit according to claim 1, wherein a thickness of the adhesive layer is greater than or equal to 0.1 mm and less than or equal to 0.5 mm.

8. A liquid crystal display apparatus at least comprising:
the light-guide plate unit according to claim 1;
a light source being arranged so as to face the incident surface of the light-guide plate; and
a liquid crystal display panel to display an image using light emitted from the emitting surface, the liquid crystal display panel being arranged so as to face the emitting surface of the light-guide plate.

9. A method for manufacturing light-guide plate unit, the method comprising:
preparing a light-guide plate comprising an incident surface on which light from a light source is to be incident, an emitting surface from which light being incident on the incident surface is to be emitted, and a back surface of the emitting surface; and an irregular reflection plate comprising an irregular reflection surface to reflect and scatter light;
providing an adhesive layer on the back surface; and
bonding the irregular reflection plate onto the back surface via the adhesive layer with the irregular reflection surface facing the light-guide plate, wherein
in preparing of the irregular reflection plate, a plurality of apertures is formed on the irregular reflection surface by forming, in the irregular reflection plate, either one or both of a plurality of recesses and a plurality of through holes; and
in bonding of the irregular reflection plate, a portion other than the apertures on the irregular reflection surface is caused to adhere to the adhesive layer.

10. The method for manufacturing light-guide plate unit according to claim 9, wherein
forming the plurality of apertures comprises pressing a plurality of projections against the irregular reflection surface, the plurality of projections being formed on a surface of a mold in a tapered shape; and,
in forming of the plurality of apertures, a size of each one of the plurality of apertures is adjusted by adjusting a force to press the plurality of projections against the irregular reflection surface.

11. The method for manufacturing light-guide plate unit according to claim 9, wherein
forming the plurality of apertures comprises, while rotating a circular cylinder-shaped mold, pressing a plurality of projections being formed on a lateral surface of the mold against the irregular reflection surface.

12. The method for manufacturing light-guide plate unit according to claim 11, wherein
in preparing of the irregular reflection plate, an irregular reflection plate collection plate comprising a plurality of the irregular reflection plates being arranged with a predetermined pitch is prepared, and
the plurality of apertures is continuously formed for the plurality of the irregular reflection plates being arranged in the irregular reflection plate collection plate using, as the circular cylinder-shaped mold, a circular cylinder-shaped mold having a length being substantially equal to the predetermined pitch as a peripheral length of a cross section being orthogonal to a direction of a central axis.

13. The light-guide plate unit according to claim 1, wherein in the irregular reflection surface, the portion other than the plurality of apertures reflects and scatters the light being incident on the incident surface.

14. The light-guide plate unit according to claim 1, wherein each one of the plurality of apertures is formed by a bottomed recess.

15. The light-guide plate unit according to claim 1, wherein the irregular reflection plate is formed using a foamed plastic.

16. The light-guide plate unit according to claim 1, wherein the irregular reflection plate is spaced from the adhesive layer at the plurality of apertures.

17. The method for manufacturing light-guide plate unit according to claim 9, wherein the plurality of apertures is formed by forming bottomed recesses in the irregular reflection plate.

18. The method for manufacturing light-guide plate unit according to claim 9, wherein a sheet-like member, a film-like member, or a hard plate-like member, being formed using a foamed plastic, is prepared as the irregular reflection plate.
